(19) United States
(12) Patent Application Publication
(10) Pub. No.: US 2026/0283245 A1
(43) Pub. Date: Sep. 24, 2026

(54) Heating Assembly for an Aerosol Generating Device and Associated Method for Obtaining Said Heating Assembly

(71) Applicant: JT International SA, Geneva (CH)

(72) Inventors: Alec Wright, Guildford (GB); Jaakko McEvoy, Vienna (AT)

(73) Assignee: JT International SA, Geneva (CH)

(21) Appl. No.: 19/490,094

(22) PCT Filed: Jun. 11, 2024
(86) PCT No.: PCT/EP2024/066090

§ 371 Date: Dec. 4, 2025

(30) Foreign Application Priority Data
Jun. 15, 2023 (EP) 23179432.2

(51) Int. Cl. A24F 40/46; A24F 40/70; H05B 3/04; H05B 3/06; H05B 3/14; H05B 3/26; H05B 3/46

(52) U.S. Cl. CPC A24F 40/46; A24F 40/70; H05B 3/04; H05B 3/06; H05B 3/141; H05B 3/265; H05B 3/46; H05B 2203/003

(57) ABSTRACT

A heating assembly for an aerosol generating device, includes:
a heating chamber made of at least two different materials one ceramic material and one metallic material,
wherein each ceramic part and each metallic part of the heating chamber, which are to be sealed together, are sealed together using a non-adhesive bond belonging to the group including a bond obtained by using: an ultrasonic transducer, or a predetermined non-adhesive solder, by thermocompression bonding, by laser welding or by depositing a metal coating performed by using vacuum metallizing processes or Mo—Mn oxide and plating processes, the depositing further including brazing or soldering together the metal coating and the metallic part, and
a heating element configured to heat the heating chamber.

### FIELD OF THE INVENTION

The present invention relates to a heating assembly for an aerosol generating device and an aerosol generating device comprising such a heating assembly. The disclosure is particularly applicable to a portable aerosol generating device, which may be self-contained and low temperature.

Particularly, the aerosol generating device according to the invention is configured to operate with a tobacco article, also called aerosol generating article, which comprises for example a solid substrate able to form aerosol when being heated. Thus, such type of aerosol generating devices, also known as heat-not-burn devices, is adapted to heat, rather than burn, the substrate by conduction, convection and/or radiation, to generate aerosol for inhalation.

The present invention also concerns a method for obtaining such a heating assembly for an aerosol generating device.

### BACKGROUND OF THE INVENTION

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm vaporizable substances as opposed to burning tobacco in conventional tobacco products.

A commonly available reduced-risk or modified-risk device is the heated substrate aerosol generation device or heat-not-burn device. Devices of this type generate aerosol or vapour by heating an aerosol substrate (i.e. an aerosol generating article) that typically comprises tobacco or other suitable vaporizable material to a temperature typically in the range 150° C. to 350° C. Heating an aerosol substrate, but not combusting or burning it, releases aerosol that comprises the components sought by the user but less the toxic and carcinogenic by-products of combustion and burning. Furthermore, the aerosol produced by heating the tobacco or other vaporizable material may or may not typically comprise the burnt or bitter taste resulting from combustion and burning that can be pleasant or unpleasant for the user and so, when the burnt or bitter taste is not desired, the substrate may not therefore require the sugars and other additives that are typically added to such materials to make the smoke and/or vapour more palatable for the user. Conversely, when desired, additional sugars can sometimes be added to suit the user tastes.

For heating an aerosol substrate, there are known heating assemblies comprising a heating chamber (i.e. oven) for receiving the aerosol substrate and heating elements for heating the heating chamber. The heating chamber is generally made from stainless steel, which permits to obtain very thin walls of the heating chamber. However, such metal heater (i.e. heating chamber) may, not intentionally, generate a focused hot spot.

Such hot spot generated by the metal heater is certainly efficient for providing the targeted heat, but the associated heat penetration in the tobacco article can be improved.

Using ceramic in the heating assembly permits advantageously to increase the thermal radiation and improve the heat transfer to the tobacco. However, the heating provided by the ceramic requires more energy than the stainless steel. Consequently, the use of the ceramic is limited around the tobacco part of the tobacco article. From this knowledge of the prior art, it results that it is preferential to use a heating chamber made of two different materials: one ceramic material and one metallic material with the interface between the two requiring to be sealed.

To seal such two different type of materials of a heating chamber, it is classically proposed to use standard glue. However, such glue or other equivalent current adhesive bond presents a low change-of-state temperature, which is not efficient to maintain sealed together the two different materials during the heating performed by said heating chamber. In other words, during the heating at a temperature higher that the change-of-state temperature of the glue (or other equivalent adhesive), the glue (other equivalent adhesive) melts and the two different material are not sealed anymore.

### SUMMARY OF THE INVENTION

The invention aims first of all at solving, how to bond said at least two different materials of a heating assembly and at least in part the drawbacks of the prior art. The invention also aims to produce a heating assembly with low complexity and reduced cost, while maintaining high performance and increased efficiency and providing improved sensory performance.

For this purpose, the invention relates to a heating assembly for an aerosol generating device, comprising:
a heating chamber having an opening for receiving an aerosol generating article, said heating chamber comprising a plurality of parts connected together, at least two parts of said plurality of parts being made of two different materials:
   one ceramic material, and
   one metallic material,
wherein each ceramic part and each metallic part of said heating chamber, which are to be sealed together, are sealed together using a non-adhesive bond belonging to the group comprising:
   a bond obtained by using an ultrasonic transducer;
   a bond obtained by using a predetermined non-adhesive solder;
   a bond obtained by thermocompression bonding;
   a bond obtained by laser welding;
   a bond obtained by depositing a metal coating onto the surface of said ceramic part where the interface with said metallic part is designed to be, said depositing being performed by using a process belonging to the group comprising:
   vacuum metallizing processes;
   Mo—Mn oxide and plating processes;
   active brazing;
said depositing further comprising brazing or soldering together said metal coating and said metallic part,
a heating element configured to heat said heating chamber.

In particular, the invention relates to a heating assembly for an aerosol generating device, comprising:
a heating chamber having an opening for receiving an aerosol generating article, said heating chamber comprising a plurality of parts connected together, at least two parts of said plurality of parts being made of two different materials:
   one ceramic material, and
   one metallic material,
wherein each ceramic part and each metallic part of said heating chamber, which are to be sealed together, are sealed together using a non-adhesive bond belonging to the group comprising:
   a bond obtained by using an ultrasonic transducer;
   a bond obtained by using a predetermined non-adhesive solder;
   a bond obtained by thermocompression bonding;
   a bond obtained by laser welding;
   a bond obtained by depositing a metal coating onto the surface of said ceramic part where the interface with said metallic part is designed to be, said depositing being performed by using a process belonging to the group comprising:
   vacuum metallizing processes;
   Mo—Mn oxide and plating processes;
said depositing further comprising brazing or soldering together said metal coating and said metallic part,
a heating element configured to heat said heating chamber.

Thanks to these features, in comparison with the heating assemblies of the prior art, the proposed heating assembly is performed by avoiding the use of an adhesive to seal together one ceramic material and one metallic material.

Indeed, according to the present invention, at least five different types of bonds, for sealing specifically together a metallic part and a ceramic part of a cup of a heating chamber, are proposed as an advantageous alternative to the current adhesive bonds. The first type of bond is obtained by using an ultrasonic transducer. The second type of bond is a bond obtained by using a predetermined non-adhesive solder. The third type of bond is a bond obtained by thermocompression bonding. The fourth type of bond is a bond obtained by laser welding. The fifth type of bond is a bond obtained by depositing a metal coating onto the surface of said ceramic part where the interface with said stainless metallic part is designed to be, said depositing being performed by using a process belonging to the group comprising:
vacuum metallizing processes;
Mo—Mn oxide and plating processes;
active brazing;
   said depositing further comprising brazing or soldering together said metal coating and said stainless metallic part.

Each of these at least five types of bonds keeps sealed the two different materials of a cup of a heating chamber, even during the heating at the target temperature that enables efficient generation of aerosol.

In some embodiments, said at least two parts are made of two different material overlapping one another at least partially.

Thanks to these features, the interface between the two different materials required to be sealed corresponds at least partially to an overlap. Such an overlap permits to increase the surface of interface (i.e. the bonding area) between said ceramic and metallic material and consequently make that bond stronger and more resistant to heat and to mechanical handling

In some embodiments, said predetermined non-adhesive solder is a S-bond.

Such an S-bond non-adhesive solder is an example of a specific solder permitting to directly solder the ceramic material to the metallic material in a one-step process.

In some embodiments, said heating chamber is configured to receive a flat-shaped tobacco article and presents a flat format wherein a metal frame is configured to hold at least one ceramic heating part, said metal frame and said ceramic heating part(s) being bonded together using one or a plurality of non-adhesive bonds belonging to the group comprising:
a bond obtained by using an ultrasonic transducer;
a bond obtained by using a predetermined non-adhesive solder;
a bond obtained by thermocompression bonding;
a bond obtained by laser welding;
a bond obtained by depositing a metal coating onto the surface of said ceramic part where the interface with said metallic part is designed to be, said depositing being performed by using a process belonging to the group comprising:
   vacuum metallizing processes;
   Mo—Mn oxide and plating processes;
   active brazing;
said depositing further comprising brazing or soldering together said metal coating and said metallic part.

In particular, said heating chamber is configured to receive a flat-shaped tobacco article and presents a flat format wherein a metal frame is configured to hold at least one ceramic heating part, said metal frame and said ceramic heating part(s) being bonded together using one or a plurality of non-adhesive bonds belonging to the group comprising:
a bond obtained by using an ultrasonic transducer;
a bond obtained by using a predetermined non-adhesive solder;
a bond obtained by thermocompression bonding;
a bond obtained by laser welding;
a bond obtained by depositing a metal coating onto the surface of said ceramic part where the interface with said metallic part is designed to be, said depositing being performed by using a process belonging to the group comprising:
vacuum metallizing processes;
Mo—Mn oxide and plating processes;
said depositing further comprising brazing or soldering together said metal coating and said metallic part.

Thanks to these features, a design of an aerosol generating device configured to operate with a flat-shaped tobacco article is provided.

In some embodiments, said heating chamber comprises:
a first tubular portion made from ceramic material,
two second tubular portions made from metal,
a heating element configured to heat said first tubular portion,
   said two second tubular portions being connected to the first tubular portion respectively at a first end of the first tubular portion and a second end of the first tubular portion which is axially opposite the first end, and said two second tubular portions being spaced in an axial direction of the heating chamber,
   said two tubular portions being connected to the first tubular portion using one or a plurality of non-adhesive bonds belonging to the group comprising:
a bond obtained by using an ultrasonic transducer;
a bond obtained by using a predetermined non-adhesive solder;
a bond obtained by thermocompression bonding;
a bond obtained by laser welding;
a bond obtained by depositing a metal coating onto the surface of said ceramic part
where the interface with said metallic part is designed to be, said depositing being performed by using a process belonging to the group comprising:
   vacuum metallizing processes;
   Mo—Mn oxide and plating processes;
   active brazing;
said depositing further comprising brazing or soldering together said metal coating and said metallic part.

In particular, said heating chamber comprises:
a first tubular portion made from ceramic material,
two second tubular portions made from metal,
a heating element configured to heat said first tubular portion,
   said two second tubular portions being connected to the first tubular portion respectively at a first end of the first tubular portion and a second end of the first tubular portion which is axially opposite the first end, and said two second tubular portions being spaced in an axial direction of the heating chamber,
   said two tubular portions being connected to the first tubular portion using one or a plurality of non-adhesive bonds belonging to the group comprising:
a bond obtained by using an ultrasonic transducer;
a bond obtained by using a predetermined non-adhesive solder;
a bond obtained by thermocompression bonding;
a bond obtained by laser welding;
a bond obtained by depositing a metal coating onto the surface of said ceramic part where the interface with said metallic part is designed to be, said depositing being performed by using a process belonging to the group comprising:
   vacuum metallizing processes;
   Mo—Mn oxide and plating processes;
said depositing further comprising brazing or soldering together said metal coating and said metallic part.

Thanks to these features, a design of an aerosol generating device corresponding to an heated tobacco stick is provided.

In some embodiments, said ceramic material is an aluminium nitride ceramic material and wherein said metallic material is stainless steel 316L or aluminium or Polyetheretherketone or polyimide.

A ceramic material corresponding to Aluminium Nitride (AlN) has a thermal conductivity of 163.1 W/m·K, which is indeed significantly higher than the one of a stainless steel 316L equal to 16.3 W·m⁻¹·K⁻¹ and improves heat transfer to the tobacco, but as previously indicated, such a ceramic material requires for heating more energy than stainless steel 316L. This is the reason why the combination of these two different materials is proposed and advantageously sealed by one of the five types of non-adhesive bonds proposed according to the present disclosure. Such a combination allows the efficient transfer of heat longitudinally in the transverse direction (in relation to the longitudinal axial direction), and it is precisely the heat spread in the transverse direction which is of interest since it travels the aerosol generating article, such as tobacco.

Silicon carbide (SiC) is an alternative to Aluminium Nitride (AlN) according to the previous embodiments. As other alternatives, silicon nitride (Si2N4) or beryllium oxide (BeO) can also be used. Indeed, such ceramic materials SiC, AlN, Si2N4 or BeO are ceramics with higher thermal conductivities compared to Alumina oxide or Zirconia for example and are therefore more suited for the present application.

Aluminium nitride is preferred in this application for obtaining said heating assembly since Sic has a lower thermal conductivity.

Aluminium could also be used as an alternative to stainless steel.

According to another aspect, the present invention also relates to an aerosol generating device comprising a battery and a heating assembly as recited above, wherein a heating element is electrically supplied by the battery.

The aerosol generating device presents the same advantages as the ones described in relation with the heating assembly.

The invention also relates to a method for obtaining a heating assembly for an aerosol generating device as recited above, said heating assembly comprising:
a heating chamber having an opening for receiving an aerosol generating article, said heating chamber comprising a plurality of parts connected together, at least two parts of said plurality of parts being made of two different materials:
   one ceramic material, and
   one metallic material,
a heating element configured to heat said heating chamber,
said method comprising a bonding step for sealing together each ceramic part and each metallic part of said heating chamber, which are to be sealed together, using a non-adhesive bond belonging to the group comprising:
a bond obtained by using an ultrasonic transducer;
a bond obtained by using a predetermined non-adhesive solder;
a bond obtained by thermocompression bonding;
a bond obtained by laser welding;
a bond obtained by depositing a metal coating onto the surface of said ceramic part where the interface with said metallic part is designed to be, said depositing being performed by using a process belonging to the group comprising:
   vacuum metallizing processes;
   Mo—Mn oxide and plating processes;
   active brazing;
      said depositing further comprising brazing or soldering together said metal coating and said metallic part.

In particular, the invention also relates to a method for obtaining a heating assembly for an aerosol generating device as recited above, said heating assembly comprising:
a heating chamber having an opening for receiving an aerosol generating article, said heating chamber comprising a plurality of parts connected together, at least two parts of said plurality of parts being made of two different materials:
   one ceramic material, and
   one metallic material,
a heating element configured to heat said heating chamber,
   said method comprising a bonding step for sealing together each ceramic part and each metallic part of said heating chamber, which are to be sealed together, using a non-adhesive bond belonging to the group comprising:
a bond obtained by using an ultrasonic transducer;
a bond obtained by using a predetermined non-adhesive solder;
a bond obtained by thermocompression bonding;
a bond obtained by laser welding;
a bond obtained by depositing a metal coating onto the surface of said ceramic part where the interface with said metallic part is designed to be, said depositing being performed by using a process belonging to the group comprising:
   vacuum metallizing processes;
   Mo—Mn oxide and plating processes;
      said depositing further comprising brazing or soldering together said metal coating and said metallic part.

According to some embodiments of said method, wherein said bonding step using a non-adhesive bond obtained by using an ultrasonic transducer comprises the following substeps:
using an ultrasonic transducer substantially operating at 20 kHz;
coupling said ultrasonic transducer substantially operating at 20 kHz with a sonotrode tip held under a clamping load of 1-10 N/mm² and creating a heat in excessive of 850° C.

According to some embodiments of said method, said predetermined non-adhesive solder is a S-bond.

According to some embodiments, said ceramic material is an aluminium nitride ceramic material and wherein said metallic material is stainless steel 316L or aluminium or Polyetheretherketone or polyimide.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a sectional view of a heating assembly according to a first embodiment of the invention through its longitudinal axis;

FIG. 2 is a perspective view of a heating assembly according to a second embodiment of the invention;

FIG. 3 corresponds to a flowchart of a method for obtaining a heating assembly for an aerosol generating device.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

The expression “substantially equal to” is understood hereinafter as an equality at plus or minus 10% and preferably at plus or minus 5%.

As used herein, the term “aerosol generating device” or “device” may include a vaping device to deliver an aerosol to a user, including an aerosol for vaping, by means of a heater element explained in further detail below. The device may be portable. “Portable” may refer to the device being for use when held by a user. The device may be adapted to generate a variable amount of aerosol, e.g. by activating the heater element for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of vaporizable material as one or more of solid particles; liquid droplets; gas. Said suspension may be in a gas including air. Aerosol herein may generally refer to/include a vapour. Aerosol may include one or more components of the vaporizable material.

As used herein, the term “vaporizable material” or “precursor” may refer to a smokable material, which may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant.

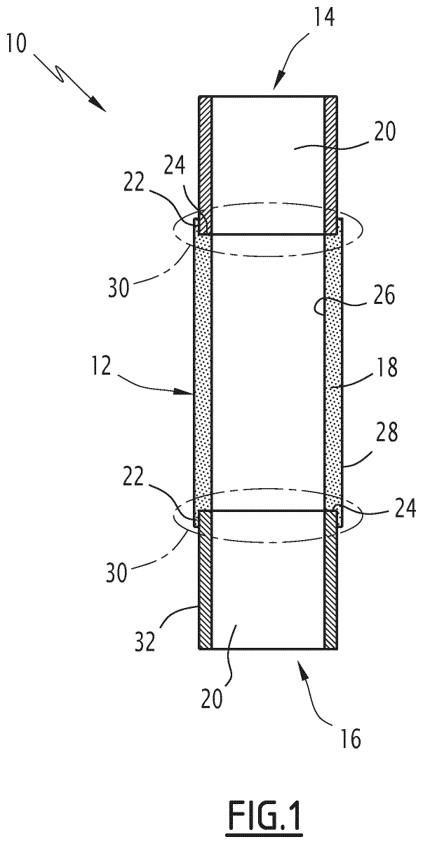

FIG. 1 shows a heating assembly of an aerosol generating device (not represented as such).

The aerosol generating device is a heat-not-burn device, which may also be referred to as a tobacco-vapour device or heated tobacco device or t-vapour device, and comprises a heating assembly 10 and a battery (not represented as such) electrically connected to the heating assembly 10.

The heating assembly 10 is configured to receive an aerosol substrate such as a rod of aerosol generating material, e.g. tobacco. The heating assembly is also configured to convert electrical energy supplied by the battery into thermal energy. To this end, the heating assembly 10 is operable to heat, but not burn, the rod of aerosol generating material to produce a vapour or aerosol for inhalation by a user. Of course, the skilled person will appreciate that the aerosol generating device is simply an exemplary aerosol generating device according to the invention. Other types and configurations of tobacco-vapour products, vaporisers, or electronic cigarettes may also be used as the aerosol generating device according to the invention.

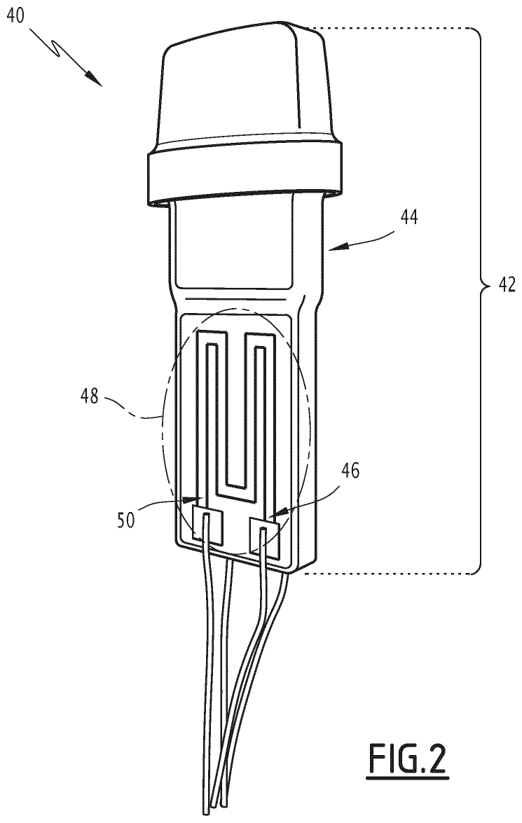

Tobacco articles, usable with such type of aerosol generating devices can take various forms. Some of them can present an elongated stick or any other suitable shape, like for example a shape as illustrated later in relation with FIG. 2.

The heating assembly 10 comprises a heating chamber 12, also referred to as a thermally conductive shell or cup, configured to hold an aerosol generating article, also referred to as a consumable, or as an aerosol substrate. In particular, the heating chamber 12 defines here a substantially cylindrical cavity or cup in which a rod of aerosol substrate may be positioned.

The heating chamber 12 is tubular, e.g. substantially cylindrical, and defines a central passage open to a first end 14 of the heating chamber 12 and a second end 16 of the heating chamber 12, axially opposite the first end 14. In other words, the central passage is accessible from each of the first end 14 and the second end 16 via openings.

Alternatively, the central passageway may have only one opening located at either of the first end and the second end of the heating chamber 12.

In use, the user may insert the aerosol substrate through an opening in the heating chamber 12 such that the aerosol substrate is positioned within the heating chamber 12 and interfaces with an inner surface of the heating chamber 12.

The length of the heating chamber 12 may be configured such that a portion of the aerosol substrate protrudes through an opening from the heating chamber 12, i.e. out of the heating assembly 10, and can be received in the mouth of the user.

According to the invention, the heating chamber 12 comprising a plurality of parts connected together, at least two parts 18 and 20 of said plurality of parts being made of two different materials:
one ceramic material, and
one metallic material.

More precisely, as illustrated by the embodiment of FIG. 1, the heating chamber 12 includes a first ceramic part 18, corresponding for example to a first tubular portion 18 and two second metallic parts 20 connected to the first ceramic part 18.

The first ceramic part 18 has here a circular cross-section and also has a first end and a second end axially opposite the first end. In other words, the first tubular ceramic part 18 is tubular, e.g. substantially cylindrical.

Alternatively, the first ceramic part 18 may be substantially cylindrical but comprises one or more flattened regions that extend in an axial direction of the heating chamber as illustrated later by FIG. 2.

The first ceramic part 18 is made from a ceramic material, and more particularly aluminium nitride (abbreviated as AlN) in the illustrated example.

Due to its construction of a ceramic material, the first ceramic part 18 has high thermal mass and provides good heat penetration into the aerosol substrate, especially when said aerosol substrate includes tobacco. This allows for improved sensory performance with a fuller vapor and a higher nicotine level when the aerosol substrate contains tobacco.

The first ceramic part 18 comprises a thinned end portion 22 at its first end and at its second end. The thinned end portion 22 has a thickness that is less than the thickness of the rest of the ceramic part 18. In particular, the inner diameter of the first ceramic part 18 at the thinned end portions 22 is greater than the inside diameter of the rest of the first ceramic part 18. In other words, the first ceramic part 18 is provided with a counterbore at its first end and at its second end.

Alternatively, the inner diameter of the first ceramic part 18 may be constant along the entire length of the first tubular portion while its outer diameter at the thinned end portions may be smaller than the outer diameter of the rest of the first ceramic part 18 corresponding to a tubular portion.

The change in diameter at the thinned end portions 22 of the first ceramic part 18 forms a shoulder 24. In the illustrated example, the shoulder 24 is formed on an inner surface 26 of the first ceramic part 18.

Alternatively, the shoulder may be formed on the outer surface of the first ceramic part 18. The thinned end portions 22 extend to a length of between 15% and 25% of the length of the first ceramic part 18. In particular, each thinned portion 22 has a length, in the longitudinal direction of the first ceramic part 18, between 0.25 mm and 2 mm, preferably between 0.75 mm and 1.5 mm and more preferably equal to 1 mm.

The thinned end portions 22 have a thickness between 0.10 mm and 0.5 mm. The first ceramic part 18 has, on the rest of his length, i.e. with the exception of the thinned end portions, has a thickness between 0.15 mm and 0.75 mm.

The heating assembly 10 comprises also a heating element (not represented on FIG. 1) configured to heat said heating chamber 12. Said heating element is configured to act as a Joule heater when supplied with electrical current. In other words, the heating element is configured to release heat in response to the flow of electrical current. This physical effect may be referred to as Joule heating, resistive heating or ohmic heating. In use, power may be supplied to the heating element from the battery for example, such that the temperature of the heating element increases and heat energy is transferred across the heating chamber 12 and more particularly to the first ceramic part 18. The aerosol substrate received within the heating assembly is conductively heated by the heating chamber 12 to produce an aerosol for inhalation by the user.

Optionally, said heating element is configured to provide an induction heating.

The heating element is for example located on an outer surface 28 of the first ceramic part 18. Alternatively, the heating element may be integrated into the first ceramic part 18, that is, located between an inner surface and an outer surface of the ceramic part 18 as illustrated later in relation with FIG. 2.

According to another alternative, the heating element may be located at a distance, i.e. not in direct contact, from the first tubular portion and transmit heat by convection for example.

The heating element is for example, as illustrated later in relation with FIG. 2, formed as a meandrous or serpentine pattern coating on the outer surface 28 of the first ceramic part 18.

The second tubular metallic portions 20 have here a circular cross-section and each have a first end and a second end axially opposite the first end. In other words, the second tubular metallic portions 20 are tubular, e.g. substantially cylindrical.

Alternatively, the second tubular metallic portions may be substantially cylindrical 20 but comprise one or more flattened regions that extend in an axial direction of the heating chamber 12 as illustrated later by FIG. 2.

Each second tubular metallic portion 20 has a constant cross-section, i.e., the outer diameter and inner diameter of the second tubular portion are constant along its length.

Alternatively, the second tubular portions have a thinned end portion, similar to the thinned end portion described for the first tubular portion, located at one end of the second tubular portions. When the second tubular portions have a thinned portion, the first tubular portion may not have a thinned end portion.

The second tubular metallic portions 20 have a thickness between 0.05 mm and 0.15 mm.

The second tubular metallic portions 20 are made from stainless steel or aluminium or Polyetheretherketone (abbreviated as PEEK) or other polymers such as polyimide for example. In some examples, PEEK may be preferred over stainless steel due to the fact that it has thermal expansion properties more similar to the ceramic material of the first ceramic part 18.

As shown in FIG. 1, the second tubular metallic portions 20 are each connected to one end of the first ceramic part 18 through the interfaces 30 (i.e. zones of interface 30).

It as to noted that, as proposed according to the present invention, each ceramic part 18 and each metallic part 20 of said cup of the heating chamber 12, which are to be sealed together, are sealed together using a non-adhesive bond belonging to the group comprising:
a bond obtained by using an ultrasonic transducer;
a bond obtained by using a predetermined non-adhesive solder;
a bond obtained by thermocompression bonding;
a bond obtained by laser welding;
a bond obtained by depositing a metal coating onto the surface of said ceramic part where the interface with said metallic part is designed to be, said depositing being performed by using a process belonging to the group comprising:
vacuum metallizing processes;
Mo—Mn oxide and plating processes;
active brazing;
said depositing further comprising brazing or soldering together said metal coating and said metallic part.

More precisely, in the embodiment of FIG. 1, wherein said heating chamber 12 comprises a first tubular portion 18 made from ceramic material, two second tubular portions 20 made from metal, and a heating element configured to heat said first tubular portion 18, said two second tubular portions 20 are connected to the first tubular portion 18 respectively at a first end of the first tubular portion and a second end of the first tubular portion 18 which is axially opposite the first end, and said two second tubular portions 20 are spaced in an axial direction of the heating chamber.

In addition, according to said embodiment of FIG. 1, said two tubular portions are connected to the first tubular portion 18 using one or a plurality of non-adhesive bonds belonging to the group comprising:
a bond obtained by using an ultrasonic transducer;
a bond obtained by using a predetermined non-adhesive solder;
a bond obtained by thermocompression bonding;
a bond obtained by laser welding;
a bond obtained by depositing a metal coating onto the surface of said ceramic part where the interface with said metallic part is designed to be, said depositing being performed by using a process belonging to the group comprising:
   vacuum metallizing processes;
   Mo—Mn oxide and plating processes;
   active brazing;
said depositing further comprising brazing or soldering together said metal coating and said metallic part.

In details, in the illustrated embodiment of FIG. 1, each second tubular metallic portion 20 is plugged, at least partially, into the first ceramic part 18 at the location of the thinned portions 22. The second tubular metallic portions 20 are inserted in translation along the longitudinal direction of the first tubular portion of the ceramic part 18 until they come into contact with the shoulder 24. The second tubular metallic portions 20 are thus axially spaced apart from each other by the first tubular portion of the ceramic part 18. Thus, the second tubular metallic portions 20 abut the first end and the second end of the first tubular portion of the ceramic part 18.

Optionally, as illustrated by the embodiment of FIG. 1, the thinned end portions 22 of the first tubular portion of the ceramic part 18 circumferentially surround at least part of the second tubular portions 20. In other words, the thinned end portions 22 of the ceramic part 18 at least partially overlap part of the second tubular metallic portions 20. Correspondingly, at least part of the second tubular portions 20 overlaps the inner surface 26 of the first tubular portion of the ceramic part 18 at the location of the thinned end portions 22.

Alternatively, at least part of the second metallic portions 20 covers (i.e. overlap partially) the outer surface of the first tubular portion of the ceramic part 18 at the location of the thinned portions or at the location of its ends in the case where the first tubular portion of the ceramic part 18 has no thinned portions.

In other words, according to an optional aspect, said at least two parts 18, 20 are made of two different material overlapping one another at least partially.

Each second tubular metallic portion 20 is inserted into the first tubular portion of the ceramic part 18 for example with a tight fit. The tight fit reduces vapor leakage and thus helps to deliver a greater amount of aerosol to the user. The tight fit also improves contact and heat exchange between the first tubular portion of the ceramic part 18 and the second tubular metallic portions 20. Thus, there is at least one contact area (i.e. interface 30) between the first tubular portion of the ceramic part 18 and the second tubular portions 20. In particular, a first contact area is located between the shoulders 24 and the surface of each second tubular portion 20 bearing against these shoulders 24. A second contact area is formed between the inner surface 26 of the first tubular portion of the ceramic part 18 at the location of the tapered portions 22 and part of the outer surface 32 of the second tubular portions 20. The second contact zone is preferably circumferential.

In order to provide the tight fit, the outer diameter of the second tubular metallic portions 20 is slightly smaller than, or equal, to the inner diameter of the first tubular portion of the ceramic part 18 at the tapered portions 22.

Alternatively, the external diameter of the first tubular ceramic portion is less than the inner diameter of the second tubular metallic portions at the thinned end portion. This is applicable when the second tubular portions comprise a thinned end portion or when the first tubular portion comprises thinned end portions and the shoulder is located on the outer surface.

Alternatively, the first tubular ceramic portion 18 and the second tubular metallic portion 20 may be joined by threading, in which case an inner or outer circumferential surface at the location of the thinned end portion is threaded. When the first tubular ceramic portion 18 comprises tapered end portions, an inner or outer surface of the second tubular metallic portions 20 is threaded so as to cooperate with the thread of the circumferential surface of the thinned end portion. When the second tubular metallic portions 20 each comprise a thinned end portion, an inner or outer surface of the first tubular portion is threaded so as to cooperate with the thread of the circumferential surface of the thinned end portion.

Alternatively, neither the first tubular ceramic portion 18 nor the second tubular metallic portion 20 have a thinned end portion. In this case, the portions are fixed end to end, i.e. by their end face, without overlapping the circumferential surface of the first tubular portion.

It has to be noted that overlapping or not, specifically according to the present invention, the portions can be maintained between them by using at least one of the at least five different types of non-adhesive bonds, for sealing together a metallic part and a ceramic part of a cup of a heating chamber, the first type of bond being obtained by using an ultrasonic transducer, the second type of bond being obtained by using a predetermined non-adhesive solder, the third type of bond being obtained by thermocompression bonding, the fourth type of bond being obtained by laser welding, the fifth type of bond is a bond being obtained by depositing a metal coating onto the surface of said ceramic part where the interface with said stainless metallic part is designed to be, said depositing being performed by using a process belonging to the group comprising:
vacuum metallizing processes;
Mo—Mn oxide and plating processes;
active brazing;
   said depositing further comprising brazing or soldering together said metal coating and said stainless metallic part.

Of course, the skilled person will appreciate that the specific type of non-adhesive bond for assembling the first tubular portion of the ceramic part 18 and the second tubular metallic portions 20 may vary, depending on the functional requirements of the heating chamber 12.

After being assembled by using one of the at least five different types of non-adhesive bonds as recited above, the first tubular ceramic portion 18 and the second tubular metallic portions 20 are sealed, such a sealing being resistant to the targeted heat required to heat the tobacco article.

FIG. 2 illustrates a second embodiment of the invention, wherein the heating assembly 40 comprises a heating chamber 42, which is configured to receive a flat-shaped tobacco article. Said flat-shaped heating chamber 42 presents a flat format wherein, for example a metal frame, 44 is configured to hold at least one ceramic heating part 46 (or according to another example not represented two ceramic heaters), said metal frame 44 and said ceramic heating part(s) 46 being bonded together, according to a zone of interface 48, using one or a plurality of non-adhesive bonds belonging to the group comprising:
a bond obtained by using an ultrasonic transducer;
a bond obtained by using a predetermined non-adhesive solder;
a bond obtained by thermocompression bonding;
a bond obtained by laser welding;
a bond obtained by depositing a metal coating onto the surface of said ceramic part where the interface with said metallic part is designed to be, said depositing being performed by using a process belonging to the group comprising:
   vacuum metallizing processes;
   Mo—Mn oxide and plating processes;
   active brazing;
said depositing further comprising brazing or soldering together said metal coating and said metallic part.

In FIG. 2, the heating element 50 of the heating assembly 40 is for example, as illustrated, formed as a meandrous or serpentine pattern coating on the outer surface of the first ceramic part 46. For example, the heating element 50 may be shaped by etching, masking, or laser cutting to form the illustrated pattern. Of course, the skilled person will appreciate that the specific pattern formed by the heating element 50 may vary, depending on the functional requirements of the heating assembly 40. The pattern forms an electrical path such that, in use, electrical current supplied from the battery to the heating element 50 travels along the electrical path and generates heat energy. The heating element 50 is made from any material that acts as a Joule heater when supplied with an electric current, such as tungsten for example. Other materials having a coefficient of thermal expansion substantially matching that of the ceramic material may be considered.

It has to be noted that as an optional preferred extra, independently from the embodiment of FIG. 1 or 2, said ceramic material is an aluminium nitride ceramic material and wherein said metallic material is stainless steel 316L or aluminium or Polyetheretherketone (abbreviated as PEEK) or other polymers such as polyimide for example.

According to another optional extra, independently from the embodiment of FIG. 1 or 2, when the bond is obtained by using a predetermined non-adhesive solder, said predetermined non-adhesive solder is a S-bond.

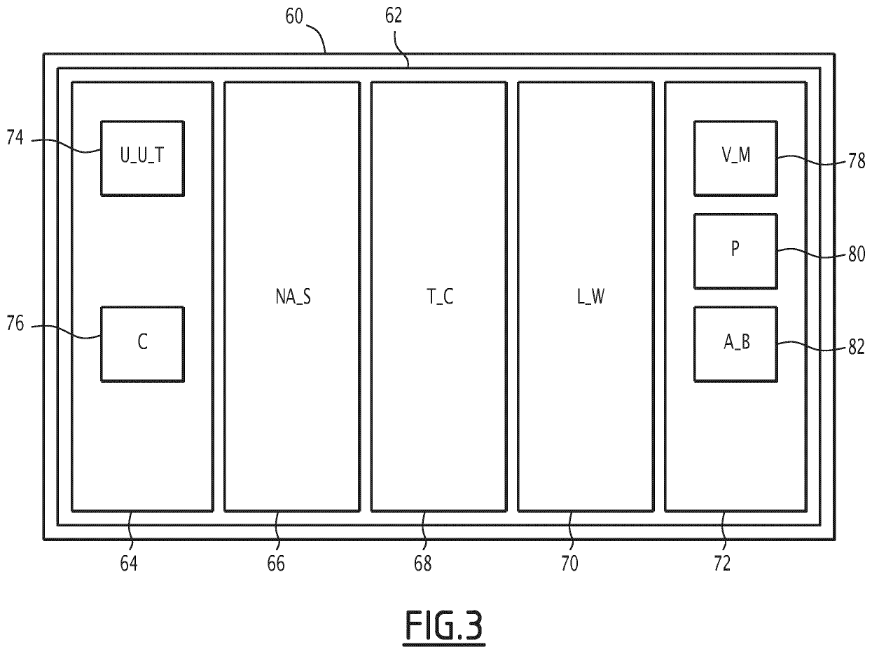

The method 60 for obtaining a heating assembly for an aerosol generating device as previously described according to the present disclosure will now be described in reference to FIG. 3 illustrating a flowchart of its steps.

As already introduced, according to the present disclosure, said heating assembly comprises a heating chamber having an opening for receiving an aerosol generating article, said heating chamber comprising a plurality of parts connected together, at least two parts of said plurality of parts being made of two different materials: one ceramic material, and one metallic material, said heating assembly further comprising a heating element configured to heat said heating chamber.

Said method 60 comprises specifically a bonding step 62 for sealing together each ceramic part and each metallic part of said heating chamber, which are to be sealed together.

According to a first option, said bonding step 62 is a step 64 of using an ultrasonic transducer.

According to a second option, said bonding step 62 is a step 66 of using a predetermined non-adhesive solder NA_S.

According to a third option, said bonding step 62 is a step 68 of using a thermocompression T_C bonding.

According to a fourth option, said bonding step 62 is a step 70 of laser welding L-W.

According to a fifth option, said bonding step 62 is a step 72 of depositing a metal coating onto the surface of said ceramic part where the interface with said metallic part is designed to be.

According to an optional aspect, said step 64 of using an ultrasonic transducer comprises a first substep 74 of using an ultrasonic transducer U_U_T substantially operating at 20 kHz, and a second substep 76 of coupling C said ultrasonic transducer substantially operating at 20 kHz with a sonotrode tip held under a clamping load of 1-10 N/mm² and creating a heat in excessive of 850° C. under which the metallic material undergoes plastic deformation. This deformation coupled with the rupture of the surface oxide brings the metal into contact with the ceramic and mechanical keying occurs along with some chemical interactions to provide the expected bond.

It has to be noted, that said step 72 of depositing a metal coating onto the surface of said ceramic part where the interface with said metallic part is designed to be, is not classic and is specifically performed by using a process belonging to the group comprising:
a substep 78 of using vacuum metallizing V_M processes;
a substep 80 of using Mo—Mn oxide and plating P processes;
a substep 82 of using active brazing A_B;
   said depositing 72 further comprising brazing or soldering together said metal coating and said metallic part to create the join.

The one skilled in the art will understand that the disclosure is not limited to the embodiments described, nor to the particular examples of the specification, the above-mentioned embodiments and variants being suitable for being combined with each other to generate new embodiments of the disclosure.

Thanks to the invention, the heating assembly 10 or 40 comprises advantageously a heating chamber made of at least two different materials, a ceramic material and a metallic material, to capitalize on their respective advantages, namely the thermal radiation of the ceramic part or parts and the metallic part which is used to limit the use of the ceramic part around the tobacco article to limit the required associated energy for heating, and the sealing of these at least two different materials thanks to one of the five types of non-adhesive bonds proposed according to the present disclosure is more resistant to heat and to mechanical handling.

1. A heating assembly for an aerosol generating device, comprising:
a heating chamber having an opening for receiving an aerosol generating article, said heating chamber comprising a plurality of parts connected together, at least two parts of said plurality of parts being made of two different materials:
one ceramic material, and
one metallic material,
wherein each ceramic part and each metallic part of said heating chamber, which are to be sealed together, are sealed together using a non-adhesive bond belonging to the group comprising:
a bond obtained by using an ultrasonic transducer;
a bond obtained by using a predetermined non-adhesive solder;
a bond obtained by thermocompression bonding;
a bond obtained by laser welding; or
a bond obtained by depositing a metal coating onto the surface of said ceramic part where the interface with said metallic part is configured to be, said depositing being performed by using a process belonging to the group comprising:
vacuum metallizing processes; or
Mo—Mn oxide and plating processes;
said depositing further comprising brazing or soldering together said metal coating and said metallic part, and
a heating element configured to heat said heating chamber.

2. The heating assembly according to claim 1, wherein said at least two parts are made of two different material overlapping one another at least partially.

3. The heating assembly according to claim 1, wherein said predetermined non-adhesive solder is a S-bond.

4. The heating assembly according to claim 1, wherein said heating chamber is configured to receive a flat-shaped tobacco article and presents a flat format wherein a metal frame is configured to hold at least one ceramic heating part, said metal frame and said ceramic heating part(s) being bonded together using one or a plurality of non-adhesive bonds belonging to the group comprising:
a bond obtained by using an ultrasonic transducer;
a bond obtained by using a predetermined non-adhesive solder;
a bond obtained by thermocompression bonding;
a bond obtained by laser welding; or
a bond obtained by depositing a metal coating onto the surface of said ceramic part where the interface with said metallic part is configured to be, said depositing being performed by using a process belonging to the group comprising:
vacuum metallizing processes; or
Mo—Mn oxide and plating processes;
said depositing further comprising brazing or soldering together said metal coating and said metallic part.

5. The heating assembly according to claim 1, wherein said heating chamber comprises:
a first tubular portion made from ceramic material,
two second tubular portions made from metal,
a heating element configured to heat said first tubular portion,
said two second tubular portions being connected to the first tubular portion respectively at a first end of the first tubular portion and a second end of the first tubular portion which is axially opposite the first end, and said two second tubular portions being spaced in an axial direction of the heating chamber,
said two tubular portions being connected to the first tubular portion using one or a plurality of non-adhesive bonds belonging to the group comprising:
a bond obtained by using an ultrasonic transducer;
a bond obtained by using a predetermined non-adhesive solder;
a bond obtained by thermocompression bonding;
a bond obtained by laser welding; or
a bond obtained by depositing a metal coating onto the surface of said ceramic part where the interface (30) with said metallic part is designed to be, said depositing being performed by using a process belonging to the group comprising:
vacuum metallizing processes; or
Mo—Mn oxide and plating processes;
said depositing further comprising brazing or soldering together said metal coating and said metallic part.

6. The heating assembly according to claim 1, wherein said ceramic material is an aluminium nitride ceramic material and wherein said metallic material is stainless steel 316L or aluminium or Polyetheretherketone or polyimide.

7. An aerosol generating device comprising a battery and a heating assembly according to claim 1, wherein said heating assembly is electrically supplied by the battery.

8. A method for obtaining a heating assembly for an aerosol generating device according to claim 1, said heating assembly comprising:
a heating chamber having an opening for receiving an aerosol generating article, said heating chamber comprising a plurality of parts connected together, at least two parts of said plurality of parts being made of two different materials:
one ceramic material, and
one metallic material,
a heating element configured to heat said heating chamber,
said method comprising a bonding step for sealing together each ceramic part and each metallic part of said heating chamber, which are to be sealed together, using a non-adhesive bond belonging to the group comprising:
a bond obtained by using an ultrasonic transducer;
a bond obtained by using a predetermined non-adhesive solder;
a bond obtained by thermocompression bonding;
a bond obtained by laser welding; or
a bond obtained by depositing a metal coating onto the surface of said ceramic part where the interface with said metallic part is configured to be, said depositing being performed by using a process belonging to the group comprising:
vacuum metallizing processes; or
Mo—Mn oxide and plating processes;
said depositing further comprising brazing or soldering together said metal coating and said metallic part.

9. The method according to claim 8, wherein said bonding step using a non-adhesive bond obtained by using an ultrasonic transducer comprises the following substeps:
using an ultrasonic transducer substantially operating at 20 kHz; and
coupling said ultrasonic transducer substantially operating at 20 kHz with a sonotrode tip held under a clamping load of 1-10 N/mm² and creating a heat in excessive of 850° C.

10. The method according to claim 8, wherein said predetermined non-adhesive solder is a S-bond.

11. The method according to according to claim 8, wherein said ceramic material is an aluminium nitride ceramic material and wherein said metallic material is stainless steel 316L or aluminium or Polyetheretherketone or polyimide.
